(19) United States
(12) Patent Application Publication
(10) Pub. No.: US 2015/0060637 A1
(43) Pub. Date: Mar. 5, 2015

(54) Sawhorse Attachment Device for Resting a Worm-drive Saw

(71) Applicant: Steve Hylden, Hastings, NE (US)

(72) Inventor: Steve Hylden, Hastings, NE (US)

(21) Appl. No.: 14/011,537

(22) Filed: Aug. 27, 2013

(51) Int. Cl. B23D 59/00; F16M 13/02; B23D 47/00

(52) U.S. Cl. CPC B23D 59/007; B23D 47/00; F16M 13/02
USPC 248/674

(57) ABSTRACT

A sawhorse attachment device which permits a hand-held electric worm-drive circular saw to be suspended from the sawhorse by the saw's handle when the attachment is affixed to the sawhorse. The device includes a base portion configured for mounting the device to a sawhorse, and a hook portion over which the auxiliary C-shaped handle of a hand-held electric worm-drive circular saw is to be placed when the saw is to be suspended from the device, the hook portion being coupled to the base portion, and extending upwardly from the base portion at an angle.

### FIELD OF THE INVENTION

The present invention relates generally to the field of carpentry and construction tools. More specifically, the present invention relates to a sawhorse attachment device that permits a user of a hand-held electric circular saw to rest the saw while not in use in a way that is convenient and safe to the user, and that prolongs the life of the saw.

### BACKGROUND OF THE INVENTION

In carpentry or construction applications, hand-held circular saws are widely used by tradesmen, such as carpenters, construction workers, etc. Hand-held electric circular saws are either side-drive or worm-drive. For side-drive electric circular saws, the blade is mounted directly to the motor's driveshaft motor, whereas for worm-drive electric circular saws, the blade is driven indirectly by a perpendicularly-mounted motor via worm gears. As such, for side-drive electric saws, the motor is located generally to the side of the blade, whereas for worm-drive electric saws, the motor is located generally to the rear the blade. Both types of saws have an asymmetrical shape, making handling them difficult.

Users of hand-held electric circular saws frequently utilize one or more sawhorses upon which to rest and secure objects that are to be cut. Because of its configuration, a typical sawhorse is not ideal for resting a hand-held electric circular saw when it is not in use, and in those situations calling for multiple uses, it is typical for the user to place the saw on the floor or ground of the worksite near the sawhorse(s) so as to be readily available for the next use. Unfortunately, placing the saw on the floor or ground of a dirty, cluttered, and/or cramped worksite frequently leads to internal or external damage to the saw. Additionally, the placement of the saw on the floor or ground of the worksite between uses requires the user to frequently bend up and down to pick up and place down the saw, all of which may result in injury and premature exhaustion to the user. Additionally, even when the power to the saw is shut off the blade may still be rotating. If the saw is placed on the floor or ground of the worksite with the blade still rotating, it may result in damage to the blade or other parts of the saws, or even worse, an injury to the user or a nearby person.

Previous attempts have been made to provide an apparatus which may support a hand-held electric side-drive circular saw adjacent to a workstation in such a way that the saw may be accessed quickly and safely. One such attempt is disclosed by U.S. Pat. No. 5,833,185. Unfortunately, no such apparatuses are known for supporting a hand-held electric worm-drive circular saw. Hence, there is a need for a convenient and safe way for a user of a hand-held electric worm-drive circular saw to rest the saw while not in use.

### SUMMARY OF THE INVENTION

It is an object of the invention to prevent damage to hand-held electric worm-drive circular saws.

It is a further object of the invention to prevent injury to users of hand-held electric worm-drive circular saws, and to persons that are near such saws.

It is a further object of the invention to make users of hand-held electric worm-drive circular saws more efficient.

In accordance with the above, and further objects of the invention, the present invention provides a sawhorse attachment device which permits a hand-held electric worm-drive circular saw to be suspended from the sawhorse by the saw's handle when the attachment is affixed to the sawhorse.

### BRIEF DESCRIPTION OF THE DRAWINGS

The following invention will be described with reference to the following drawings of which:

FIGS. 1 and 2 are isometric perspective views of a preferred embodiment of a sawhorse attachment device of the invention.

FIG. 3 is a diagrammatic representation of a preferred embodiment of a sawhorse attachment device of the invention upon which a hand-held electric worm-drive circular saw is suspended by its handle.

FIG. 4 is a diagrammatic representations of a preferred embodiment of a sawhorse attachment device of the invention upon which a hand-held electric worm-drive circular saw is suspended by its handle, which device is mounted to a sawhorse.

### DETAILED DESCRIPTION OF THE INVENTION

The term “coupled” is defined as connected or attached or welded, although not necessarily directly, and not necessarily mechanically.

The terms “a” and “an” are defined as one or more unless this disclosure explicitly requires otherwise.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a method or device that “comprises,” “has,” “includes” or “contains” one or more steps or elements possesses those one or more steps or elements, but is not limited to possessing only those one or more elements. Likewise, a step of a method or an element of a device that “comprises,” “has,” “includes” or “contains” one or more features possesses those one or more features, but is not limited to possessing only those one or more features. Furthermore, a device or structure that is configured in a certain way is configured in at least that way, but may also be configured in ways that are not listed.

The term “hand-held electric worm-drive circular saw” is defined as any hand-held electric circular saw in which the blade is driven indirectly by a perpendicularly-mounted motor via worm gears, and which includes a C-shaped auxiliary handle that is positioned above the motor casing. An example is the well-known SKILSAW® Model 77 worm-drive saw. Another example is as shown and described in U.S. Publ. No. 20130152407 A1.

The present invention now will be described more fully hereinafter with reference to the accompanying drawings, in which some, but not all embodiments of the inventions are shown. While the following description details the preferred embodiments of the present invention is not limited in its application to the details of construction and arrangement of the parts illustrated in the accompanying drawings.

With reference to the figures, numerical designations have been given for each element to facilitate the reader's understanding of the present invention, and particularly with reference to the embodiments of the present invention illustrated in the figures; various preferred embodiments of the present invention are set forth below. The enclosed description and drawings are merely illustrative of preferred embodiments and represent several different ways of configuring the present invention. Although specific components, materials, configurations and uses of the present invention are illustrated and set forth in this disclosure, it should be understood that a number of variations to the components and to the configuration of those components described herein and in the accompanying figures can be made without changing the scope and function of the invention set forth herein.

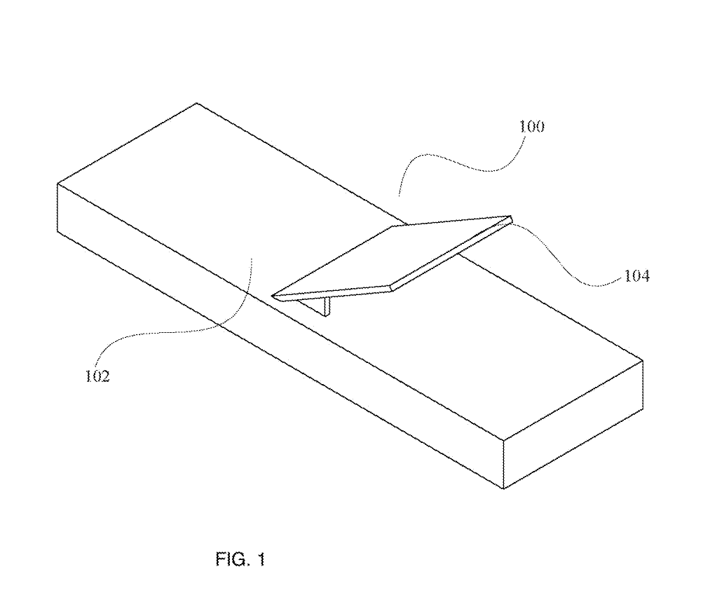

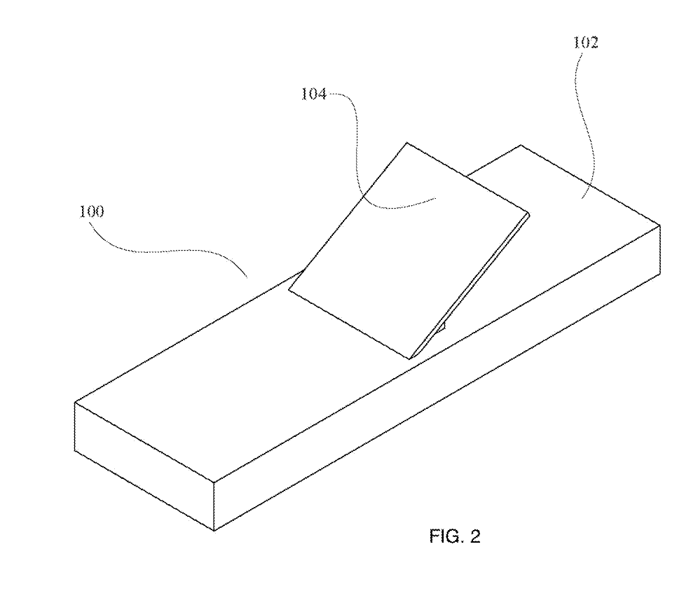

Referring to FIG. 1 and FIG. 2, two isometric perspective views of a preferred embodiment of a sawhorse attachment device (100) as described herein are shown, which device (100) comprises a base portion (102) configured for mounting the device (100) to a sawhorse (not shown), and a hook portion (104) over which the auxiliary C-shaped handle (not shown) of the hand-held electric worm-drive circular saw (not shown) is to be placed when the saw is to be suspended from the device (100), the hook portion (104) being coupled to the base portion (102), and extending upwardly from the base portion (102) at an angle.

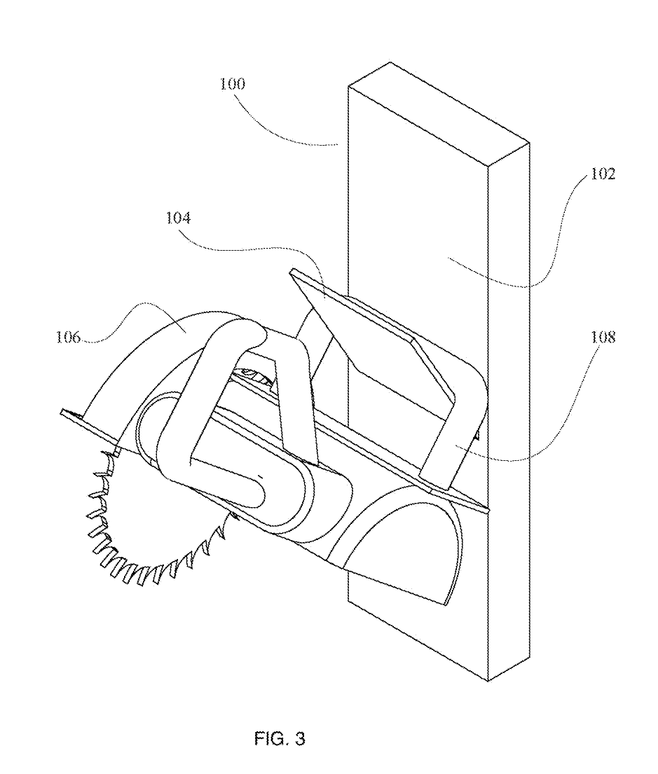

Referring to FIG. 3, a diagrammatic representation of a preferred embodiment of a sawhorse attachment device (100) as described herein is shown, which device (100) comprises a base portion (102) configured for mounting the device (100) to a sawhorse (not shown), and a hook portion (104) over which the C-shaped auxiliary handle (108) of the hand-held electric worm-drive circular saw (106) is to be placed when the saw (106) is to be suspended from the device (100), the hook portion (104) being coupled to the base portion (102), and extending upwardly from the base portion (102) at an angle.

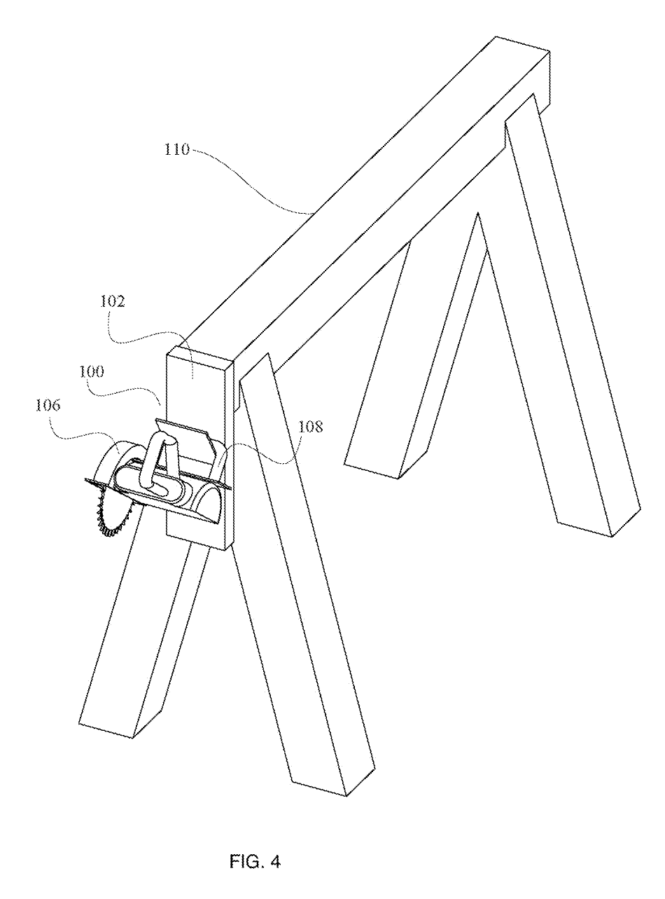

Referring to FIG. 4, a diagrammatic representation of a preferred embodiment of a sawhorse attachment device (100) as described herein is shown, which device (100) comprises a base portion (102) for mounting the device (100) to a sawhorse (110), and a hook portion (104) over which the C-shaped auxiliary handle (108) of the hand-held electric worm-drive circular saw (106) is to be placed when the saw (106) is to be suspended from the device (100), the hook portion (104) being coupled to the base portion (102), and extending upwardly from the base portion (102) at an angle.

The hook portion (104) may be coupled to the base portion (102) by any suitable means, including by welding, glue, brazing, soldering or screws.

In a most preferred embodiment, the base portion (102) of the device includes one or more openings for insertion of a screw, bolt, or nail for further securing the device when mounted to a sawhorse.

Additional supports may be employed between the base portion (102) and the hook portion (104) to provide further support to the hook portion (104) when the device (100) is mounted to a sawhorse and a hand-held electric worm-drive circular saw is suspended therefrom via its C-shaped auxiliary handle.

The base portion (102) and hook portion (104) are preferably composed of metal, for example, 16 to 20 gauge steel, although other suitable materials, such as a high strength plastic material, may be employed; the only requirement is that the device (100) be strong and durable enough permit a worm-drive saw to be repeatedly suspended from it when the device (100) is mounted to a sawhorse.

The base portion (102) is generally rectangular, and has a length of preferably 11 to 13 inches, and most preferably 12 inches, and a width of preferably 3.25 to 4.25 inches, and most preferably 3.75 inches.

The hook portion (104) is generally rectangular, and has a length of preferably 5 to 6 inches, and most preferably 5.5 inches, and a width of preferably 3 to 3.5 inches, and most preferably 3.25 inches.

The angle at which the hook portion (104) extends upwardly from the base portion (102) is 25 to 30 degrees, and most preferably 30 degrees.

The foregoing descriptions of specific embodiments of the present disclosure have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. A sawhorse attachment device for suspending a hand-held electric worm-drive circular saw by its handle, the device comprising:
a base portion configured for mounting the device to the sawhorse; and
a hook portion for suspending the saw from the device, the hook portion being coupled to the base portion and extending upwardly from the base portion at an angle.

2. The sawhorse attachment device of claim 1, wherein the length of the base portion is 12 inches, the width of the base portion is 3.75 inches, the length of the hook portion is 5.5 inches, and the width of the hook portion is 3.25 inches.

3. The sawhorse attachment device of claim 1, wherein the angle at which the hook portion extends upwardly from the base portion is 30 degrees.
